(19) United States
(12) Patent Application Publication
(10) Pub. No.: US 2026/0340622 A1
(43) Pub. Date: Oct. 29, 2026

(54) NFC DEVICE-TO-DEVICE PAYMENT SYSTEM

(71) Applicant: TAPREADY INC., Dover, DE (US)

(72) Inventors: Gideon Mojolaoluwa, Dover, DE (US); Oluwapelumi Ajayi, Toronto (CA)

(73) Assignee: TAPREADY INC., Dover, DE (US)

(21) Appl. No.: 19/653,883

(22) Filed: Apr. 21, 2026

Related U.S. Application Data
(60) Provisional application No. 63/793,965, filed on Apr. 24, 2025.
(60) Provisional application No. 63/922,624, filed on Nov. 21, 2025.

(51) Int. Cl. G06Q 20/32; G06Q 20/22; G06Q 20/36

(52) U.S. Cl. CPC G06Q 20/3278; G06Q 20/223; G06Q 20/367

(57) ABSTRACT

The present invention relates to systems and methods for enabling digital currency tokenization and peer-to-peer (P2P) transactions via Near-Field Communication (NFC), especially in areas with limited connectivity or banking infrastructure. It introduces a universal platform that tokenizes telecom-issued digital currencies, bank cards, and/or stablecoins for use in offline and online NFC-based payments. The platform includes a hybrid wallet stored on mobile devices that supports dual NFC modes (card/terminal) and offline P2P transactions while tokenized identification data and transaction attestation ensures regulatory compliance without compromising user privacy.

### CROSS REFERENCES TO RELATED APPLICATIONS

This application is related to and claims priority from the following U.S. patents and/or patent applications. This application claims priority to and the benefit of U.S. Provisional Patent Application No. 63/793,965, filed Apr. 24, 2025, and U.S. Provisional Patent Application No. 63/922,624, filed Nov. 21, 2025. Each of the above listed patents and/or patent applications is incorporated herein by reference in its entirety.

### BACKGROUND OF THE INVENTION

### 1. Field of the Invention

The present invention relates to systems and methods for facilitating peer-to-peer mobile device NFC transactions, and more specifically to a platform that allows for the dynamic tokenization of telecom-based currency for offline NFC P2P ledger-based transactions.

### 2. Description of the Prior Art

It is generally known in the prior art to provide NFC payment systems.

U.S. Patent Publication No. 2024/0296435 for GROUP PEER-TO-PEER FINANCIAL TRANSACTIONS by inventors Gloria Lin et al., filed May 15, 2024, and published Sep. 5, 2024, is directed to user interfaces for displaying a transfer request, detecting user input directed to initiating a transfer corresponding to the request, and receiving authentication information to authorize the transfer corresponding to the request.

U.S. Patent Publication No. 2023/0079223 for a DEVICE FOR LAUNCHING MULTIPLE PEER TO PEER CASHLESS PAYMENT APPLICATIONS ON MOBILE DEVICES by inventor Sergio Nicolas Ducoulombier, filed Nov. 20, 2022, and published Mar. 16, 2023, is directed to a device that includes one or more NFC chips that are preprogrammed to provide a payee's identification and information for launching any of several P2P cashless payment applications to which the payee is subscribed, to a mobile phone of a payor. When a mobile device of a payor is brought to the vicinity of an NFC chip of the device, the mobile device launches a corresponding P2P cashless payment application. The P2P cashless payment application shows the payee's information, and the payor may proceed to make a payment to the payee. The device may include an NFC chip that is preprogrammed to provide the payee's identification and the information for launching a single application on the mobile device of the payor to display the P2P cashless payment applications to which the payee is subscribed. The payor may then proceed to make a payment to the payee using the payor's mobile device.

U.S. Patent Publication No. 2022/0222647 for GROUP PEER-TO-PEER FINANCIAL TRANSACTIONSMENT by inventors Gloria Lin et al., filed Nov. 16, 2021, and published Jul. 14, 2022, is directed to user interfaces for displaying a transfer request, detecting user input directed to initiating a transfer corresponding to the request, and receiving authentication information to authorize the transfer corresponding to the request.

U.S. Patent Publication No. 2022/0036340 for a SYSTEM AND METHOD OF OPERATING A SECURE CONTACTLESS TRANSACTION by inventors Eran Hollander et al., filed Oct. 15, 2021, and published Feb. 3, 2022, is directed to a method and system for authorizing payment for a transaction between a buyer and a seller. A payment request may be received from a device associated with the seller. An authentication request comprising transaction information may be transmitted to an authentication service. An indication that the buyer has been authenticated may be received from the authentication service. A transaction request may be transmitted after the buyer has been authenticated.

U.S. Patent Publication No. 2021/0012339 for TECHNIQUES TO ELECTRONICALLY SHARE TRANSACTION CARD INFORMATION by inventors Galen RAFFERTY et al., filed Jul. 8, 2019, and published Jan. 14, 2021, is directed to techniques for sharing transaction card information with another device. More specifically, embodiments discussed here include sharing transaction card information from one device to another device, such as a mobile phone or transaction card, such that a user of the other device may perform one or more authorized transactions.

U.S. Patent Publication No. 2019/0266587 for GROUP PEER-TO-PEER FINANCIAL TRANSACTIONS by inventors Gloria Lin et al., filed May 15, 2019, and published Aug. 29, 2019, is directed to user interfaces for displaying a transfer request, detecting user input directed to initiating a transfer corresponding to the request, and receiving authentication information to authorize the transfer corresponding to the request.

U.S. Patent Publication No. 2016/0055486 for APPLICATION SERVER AND MOBILE DEVICE FOR IMPLEMENTING AN ENHANCED MOBILE WALLET by inventor Markus Hueck, filed Nov. 4, 2015, and published Feb. 25, 2016, is directed to a mobile device and application server, configured to implement a Mobile Wallet (mWallet) facility capable of storing a quanta of value, and enabling a user of the mobile device to update the quanta of value stored in the mWallet, as well as engage in a transaction with a merchant system so that the user may use the mobile device to complete at least the payment portion of the transaction using only their mobile phone.

U.S. Patent Publication No. 2011/0066550 for SYSTEM AND METHOD FOR A SECURE FUNDS TRANSFER by inventors Clinton L. Shank and Mark A. Brousseau, filed Sep. 16, 2009, and published Mar. 17, 2011, is directed to a gateway receives a transaction from a first device in local communication with a second device. The transaction includes a payment amount and a plurality of authorization codes. The gateway uses the authorization codes to authorize the transaction and to determine an account for each device. The gateway then instructs an account manager to withdraw the payment amount from the account of the first device and to deposit it into the account of the second device. A result is received at the gateway, and the gateway sends the result to each device.

U.S. Patent Publication No. 2010/0082490 for SYSTEMS AND METHODS FOR SECURE WIRELESS TRANSACTIONS by inventors Michael Rosenblatt et al., filed Sep. 30, 2008, and published Apr. 1, 2010, is directed to a system and methods for conducting wireless transactions using portable electronic devices. Specifically, for example, a method of conducting a wireless transaction is provided that includes initiating a wireless transaction using a short range wireless communication system of a portable electronic device. The method also includes obtaining security information via at least one secondary system of the portable electronic device and utilizing the security information obtained via the at least one secondary system to authenticate the portable electronic device for the wireless transaction.

U.S. Patent Publication No. 2010/0078472 for GROUP PEER-TO-PEER FINANCIAL TRANSACTIONS by inventors Gloria Lin et al., filed Sep. 30, 2008, and published Apr. 1, 2010, is directed to peer-to-peer financial transactions using one or more electronic devices. In one embodiment, a request for payment is transmitted from a first device to a second device using a near field communication (NFC) interface. In response to the request, the second device may transmit payment information to the first device. The first device may select a crediting account and, using a suitable communication protocol, may communicate the received payment information and selected crediting account to one or more external financial servers configured to process and determine whether the payment may be authorized. If the payment is authorized, a payment may be credited to the selected crediting account. In a further embodiment, a device may include a camera configured to obtain an image of a payment instrument. The device may further include an application to extract payment information from the acquired image.

U.S. Pat. No. 11,924,186 for WIRELESS PEER-TO-PEER MOBILE WALLET CONNECTIONS by inventors Thomas Hayes et al., filed Mar. 17, 2023, and issued Mar. 5, 2024, is directed to devices, systems, and machine readable mediums for establishing peer to peer mobile wallet communications (P2PMW) over short range wireless communication networks. These P2PMW communications allow exchange of information between two wallet clients. Example communications include payments, providing identification, providing loans, and the like. The use of P2PMW communications opens up the prospect of anyone accepting payment from anybody else at any time. All that is needed is a computing device with a mobile wallet. Example short range wireless communications include Wireless LANs (WLAN) such as WIFI (e.g., communicating according to an Institute for Electrical and Electronics Engineers (IEEE) 802.11 family of standards), BLUETOOTH® or the like.

### SUMMARY OF THE INVENTION

The present invention relates to systems and methods for facilitating peer-to-peer mobile device NFC transactions, and more specifically to a platform that allows for the dynamic tokenization of telecom-based currency for offline NFC P2P ledger-based transactions.

It is an object of this invention to improve peer-to-peer transactions for travelers and locals in low connectivity and emerging markets.

In one embodiment, the present disclosure includes a system for facilitating near-field communication (NFC) device-to-device transactions including a user device including an NFC interface, a processor, and a non-transitory memory; a digital wallet stored on or accessible by the user device; a tokenization engine configured to convert a telecom-issued currency, fiat currency, or cryptocurrency into one or more tokenized values; a local ledger stored on the user device; and an identity module configured to extract identity data from a machine-readable zone of a passport using a camera of the user device and to extract NFC-based identity data from an NFC-enabled passport chip of the passport using an NFC chip of the user device; wherein the extracted identity data and the extracted NFC-based identity data are cross-verified and tokenized to create tokenized identity data for a user of the user device; wherein the digital wallet is operable to store the one or more tokenized values; wherein the NFC interface is configured to transmit the one or more tokenized values between the user device and a second user device via NFC; wherein the local ledger includes a transaction log of signed transactions and a netted balance structure representing obligations between the user device and the second user device; wherein the local ledger enables an offline token framework to execute the transmission of the one or more tokenized values between the user device and the second user device via NFC without network connectivity; and wherein the transaction log of signed transactions includes the tokenized identity data for the user and tokenized identity data for a second user of the second user device. In one embodiment the system further includes a secure storage element including a secure enclave, SIM card, or eSIM, configured to store tokenized identity data and/or the digital wallet containing the one or more tokenized values. In one embodiment the NFC interface is operable to operate in dual modes including a card mode in which the user device emulates an NFC payment card or a terminal mode in which the user device accepts NFC payments from the second user device. In one embodiment, the local ledger includes a Merkle tree structure configured to store the transaction log of signed transactions and generate Merkle roots for synchronization. In one embodiment, the system further includes a smart contract interface configured to receive synchronized transaction summaries, verify identity signatures from the tokenized identity data for the user, the tokenized identity data for the second user, and the Merkle roots, and execute settlement operations. In one embodiment, the netted balance structure is configured to compute net obligations between multiple counterparties to reduce a number of settlement transactions. In one embodiment, the settlement transactions do not occur in near-real-time with respect to the transmission of the one or more tokenized values between the user device and the second user device via NFC.

In another embodiment, the present disclosure includes a method for facilitating near-field communication (NFC) device-to-device transactions including, converting, by a tokenization engine, at least one of telecom-issued currency, fiat currency, or cryptocurrency into one or more tokenized values; extracting, by an identity module, identity data from a machine-readable zone of a passport using a camera of the user device, wherein the user device includes a local ledger, an NFC interface, a processor, and a digital wallet; extracting, by the identity module, NFC-based identity data from an NFC-enabled passport chip of the passport using an NFC chip of the user device; cross-verifying and tokenizing the extracted identity data and the extracted NFC-based identity data to create tokenized identity data for a user of the user device; storing, by the digital wallet, the one or more tokenized values; transmitting, by the NFC interface, the one or more tokenized values between the user device and a second user device via NFC; maintaining, by the local ledger, a transaction log of signed transactions and a netted balance structure representing obligations between the user device and the second user device; and executing, by the local ledger, an offline token framework to execute the transmission of the one or more tokenized values between the user device and a second user device via NFC without network connectivity, wherein the transaction log of signed transactions includes the tokenized identity data for the user and tokenized identity data for a second user of the second user device. In one embodiment, the method further includes storing, in a secure storage element including a secure enclave, SIM card, or eSIM, the tokenized identity data and/or the digital wallet containing the one or more tokenized values. In one embodiment, the method further includes operating the NFC interface in dual modes including a card mode in which the user device emulates an NFC payment card or a terminal mode in which the user device accepts NFC payments from the second user device. In one embodiment, the method further includes storing, by the local ledger, the transaction log of signed transactions in a Merkle tree structure and generating Merkle roots for synchronization. In one embodiment, the method further includes receiving synchronized transaction summaries via a smart contract interface, verifying identity signatures from the tokenized identity data for the user, the tokenized identity data for the second user, and the Merkle roots, and executing settlement operations. In one embodiment, the method further includes computing, by the netted balance structure, net obligations between multiple counterparties to reduce a number of settlement transactions. In one embodiment, the method further includes storing, in the netted balance structure, metadata including a currency of the transaction, an exchange conversion rate, a rate source identifier, and a timestamp.

In another embodiment, the present disclosure includes a system for facilitating near-field communication (NFC) device-to-device transactions including a user device including an NFC interface, a processor, and a non-transitory memory; a digital wallet stored on or accessible by the user device; a tokenization engine configured to convert at least one of telecom-issued currency, fiat currency, or cryptocurrency into one or more tokenized values; a network-based ledger; and an identity module configured to extract identity data from a machine-readable zone of a passport using a camera of the user device and to extract NFC-based identity data from an NFC-enabled passport chip of the passport using an NFC chip of the user device, wherein the extracted identity data and the extracted NFC-based identity data are cross-verified and tokenized to create tokenized identity data for a user of the user device; wherein the digital wallet is operable to store the one or more tokenized values; wherein the NFC interface is configured to transmit the one or more tokenized values between the user device and a second user device via NFC; wherein the network-based ledger includes a transaction log of signed transactions between the user device and the second user device; and wherein the transaction log of signed transactions includes the tokenized identity data for the user and tokenized identity data for a second user of the second user device. In one embodiment, the system further includes a secure storage element including a secure enclave, SIM card, or eSIM, configured to store tokenized identity data and/or the digital wallet containing the one or more tokenized values. In one embodiment, the NFC interface is operable to operate in dual modes including a card mode in which the user device emulates an NFC payment card or terminal mode in which the user device accepts NFC payments from the second user device. In one embodiment, the network-based ledger includes a Merkle tree structure configured to store the transaction log of signed transactions and generate Merkle roots for synchronization. In one embodiment, the system further includes a smart contract interface configured to receive synchronized transaction summaries, verify identity signatures from the tokenized identity data for the user, the tokenized identity data for the second user, and the Merkle roots, and execute settlement operations. In one embodiment, the transaction log of signed transactions includes metadata including a currency of the transaction, an exchange conversion rate, a rate source identifier, and a timestamp.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a device-based passport camera reader according to one embodiment of the present invention.

FIG. 2 illustrates a device-based passport near-field communication (NFC) reader according to one embodiment of the present invention.

FIG. 3 illustrates a flowchart for an identity-anchored transaction attestation public key infrastructure.

FIG. 4 illustrates device-to-device NFC payments according to one embodiment of the present invention.

FIG. 5 illustrates card-to-device NFC payments according to one embodiment of the present invention.

FIG. 6 illustrates device-to-terminal NFC payments according to one embodiment of the present invention.

FIG. 7 illustrates a user device login/signup portal screen for the platform according to one embodiment of the present invention.

FIG. 8 illustrates a user device login screen for the platform according to one embodiment of the present invention.

FIG. 9 illustrates a user device signup screen for the platform according to one embodiment of the present invention.

FIG. 10 is a schematic diagram according to one embodiment of the present invention.

### DETAILED DESCRIPTION

The present invention relates to systems and methods for facilitating peer-to-peer mobile device NFC transactions, and more specifically to a platform that allows for the dynamic tokenization of telecom-based currency for offline NFC P2P ledger-based transactions.

In one embodiment, the present disclosure includes a system for facilitating near-field communication (NFC) device-to-device transactions including a user device including an NFC interface, a processor, and a non-transitory memory; a digital wallet stored on or accessible by the user device; a tokenization engine configured to convert a telecom-issued currency, fiat currency, or cryptocurrency into one or more tokenized values; a local ledger stored on the user device; and an identity module configured to extract identity data from a machine-readable zone of a passport using a camera of the user device and to extract NFC-based identity data from an NFC-enabled passport chip of the passport using an NFC chip of the user device; wherein the extracted identity data and the extracted NFC-based identity data are cross-verified and tokenized to create tokenized identity data for a user of the user device; wherein the digital wallet is operable to store the one or more tokenized values; wherein the NFC interface is configured to transmit the one or more tokenized values between the user device and a second user device via NFC; wherein the local ledger includes a transaction log of signed transactions and a netted balance structure representing obligations between the user device and the second user device; wherein the local ledger enables an offline token framework to execute the transmission of the one or more tokenized values between the user device and the second user device via NFC without network connectivity; and wherein the transaction log of signed transactions includes the tokenized identity data for the user and tokenized identity data for a second user of the second user device. In one embodiment the system further includes a secure storage element including a secure enclave, SIM card, or eSIM, configured to store tokenized identity data and/or the digital wallet containing the one or more tokenized values. In one embodiment the NFC interface is operable to operate in dual modes including a card mode in which the user device emulates an NFC payment card or a terminal mode in which the user device accepts NFC payments from the second user device. In one embodiment, the local ledger includes a Merkle tree structure configured to store the transaction log of signed transactions and generate Merkle roots for synchronization. In one embodiment, the system further includes a smart contract interface configured to receive synchronized transaction summaries, verify identity signatures from the tokenized identity data for the user, the tokenized identity data for the second user, and the Merkle roots, and execute settlement operations. In one embodiment, the netted balance structure is configured to compute net obligations between multiple counterparties to reduce a number of settlement transactions. In one embodiment, the settlement transactions do not occur in near-real time with respect to the transmission of the one or more tokenized values between the user device and the second user device via NFC. In the current disclosure, “near-real-time” as used herein is described as not instantaneous but accounts for the time delay introduced by automated data processing or network transmission between the occurrence of an event and the use of the processed data, and one of ordinary skill in the art could interpret this to mean within 5 seconds to 1 minute from initiation a transaction. In the current disclosure this term is used to describe an offline transaction where the recordation on a network-based ledger does not occur in near-real-time but upon the device or a second device having a record of the transaction on its local ledger connecting to a network. One of ordinary skill of the art could understand the settlement transactions do not occur in near-real-time with respect to the transmission of one or more tokenized values when offline but instead occur at least 5 minutes after the transaction is recorded on the local ledger or when a device with a recordation of the transaction connects to a network. This represents an improvement to existing payment processing technology and to computer technology.

In another embodiment, the present disclosure includes a method for facilitating near-field communication (NFC) device-to-device transactions including, converting, by a tokenization engine, at least one of telecom-issued currency, fiat currency, or cryptocurrency into one or more tokenized values; extracting, by an identity module, identity data from a machine-readable zone of a passport using a camera of the user device, wherein the user device includes a local ledger, an NFC interface, a processor, and a digital wallet; extracting, by the identity module, NFC-based identity data from an NFC-enabled passport chip of the passport using an NFC chip of the user device; cross-verifying and tokenizing the extracted identity data and the extracted NFC-based identity data to create tokenized identity data for a user of the user device; storing, by the digital wallet, the one or more tokenized values; transmitting, by the NFC interface, the one or more tokenized values between the user device and a second user device via NFC; maintaining, by the local ledger, a transaction log of signed transactions and a netted balance structure representing obligations between the user device and the second user device; and executing, by the local ledger, an offline token framework to execute the transmission of the one or more tokenized values between the user device and a second user device via NFC without network connectivity, wherein the transaction log of signed transactions includes the tokenized identity data for the user and tokenized identity data for a second user of the second user device. In one embodiment, the method further includes storing, in a secure storage element including a secure enclave, SIM card, or eSIM, the tokenized identity data and/or the digital wallet containing the one or more tokenized values. In one embodiment, the method further includes operating the NFC interface in dual modes including a card mode in which the user device emulates an NFC payment card or a terminal mode in which the user device accepts NFC payments from the second user device. In one embodiment, the method further includes storing, by the local ledger, the transaction log of signed transactions in a Merkle tree structure and generating Merkle roots for synchronization. In one embodiment, the method further includes receiving synchronized transaction summaries via a smart contract interface, verifying identity signatures from the tokenized identity data for the user, the tokenized identity data for the second user, and the Merkle roots, and executing settlement operations. In one embodiment, the method further includes computing, by the netted balance structure, net obligations between multiple counterparties to reduce a number of settlement transactions. In one embodiment, the method further includes storing, in the netted balance structure, metadata including a currency of the transaction, an exchange conversion rate, a rate source identifier, and a timestamp.

In another embodiment, the present disclosure includes a system for facilitating near-field communication (NFC) device-to-device transactions including a user device including an NFC interface, a processor, and a non-transitory memory; a digital wallet stored on or accessible by the user device; a tokenization engine configured to convert at least one of telecom-issued currency, fiat currency, or cryptocurrency into one or more tokenized values; a network-based ledger; and an identity module configured to extract identity data from a machine-readable zone of a passport using a camera of the user device and to extract NFC-based identity data from an NFC-enabled passport chip of the passport using an NFC chip of the user device, wherein the extracted identity data and the extracted NFC-based identity data are cross-verified and tokenized to create tokenized identity data for a user of the user device; wherein the digital wallet is operable to store the one or more tokenized values; wherein the NFC interface is configured to transmit the one or more tokenized values between the user device and a second user device via NFC; wherein the network-based ledger includes a transaction log of signed transactions between the user device and the second user device; and wherein the transaction log of signed transactions includes the tokenized identity data for the user and tokenized identity data for a second user of the second user device. In one embodiment, the system further includes a secure storage element including a secure enclave, SIM card, or eSIM, configured to store tokenized identity data and/or the digital wallet containing the one or more tokenized values. In one embodiment, the NFC interface is operable to operate in dual modes including a card mode in which the user device emulates an NFC payment card or terminal mode in which the user device accepts NFC payments from the second user device. In one embodiment, the network-based ledger includes a Merkle tree structure configured to store the transaction log of signed transactions and generate Merkle roots for synchronization. In one embodiment, the system further includes a smart contract interface configured to receive synchronized transaction summaries, verify identity signatures from the tokenized identity data for the user, the tokenized identity data for the second user, and the Merkle roots, and execute settlement operations. In one embodiment, the transaction log of signed transactions includes metadata including a currency of the transaction, an exchange conversion rate, a rate source identifier, and a timestamp.

None of the prior art discloses a currency transfer system, or a system for transferring currency from device to device using NFC technology, that utilizes tokenized telecom-based currency for offline NFC P2P ledger-based transactions that function in areas of low or no connectivity and/or in unbanked or underbanked areas.

Conducting financial transactions and currency exchange remains a significant challenge for both locals and travelers, especially in emerging markets where payment systems are not standardized, reliable connectivity and power are limited, and access to traditional banking services (e.g., credit or debit cards) is scarce. These regions often rely on local cards, telecom-issued currencies (e.g., mobile money), or digital wallets that are often not compatible with international payment systems or newer NFC-based device-to-device technologies. This lack of interoperability creates inefficiencies and limits financial accessibility for both locals and travelers who wish to easily transfer currency for goods or services.

While certain digital payment solutions like Apple Pay and Google Pay exist, these solutions depend heavily on internet connectivity and banking infrastructure for transaction authentication. Additionally, access to the NFC functionality of mobile devices is restricted by platform owners, limiting third-party use. On the other hand, existing mobile money and similar telecom currency systems are often siloed within individual telecom providers, hindering cross-network interoperability and making it difficult for travelers to use these systems effectively. These systems also lack the convenience and security offered by NFC technology.

To address these challenges, the present invention provides a platform for tokenizing telecom-issued digital currencies (e.g., mobile money, airtime credits) and/or stablecoins for use in NFC-based transactions. The platform enables the spending of local digital currencies abroad in emerging markets with comparable ease to a credit card, while also allowing foreign travelers to convert preexisting payment methods into formats accepted locally. By utilizing NFC, a globally recognized standard for contactless payments, the platform ensures compatibility across various financial ecosystems.

Unlike existing NFC payment platforms that rely on banking infrastructure, the platform described herein supports direct integration with telecom-issued digital currencies and cryptocurrencies (e.g., stablecoins, Bitcoin), in addition to debit cards, credit cards, traditional bank accounts, and/or local bank cards. This reduces dependence on banks and promotes financial inclusion in underbanked or unbanked regions.

In one embodiment, the platform provides a universal digital wallet that is funded via bank accounts, telecom-issued digital currencies (i.e., mobile money), debit cards, credit cards, local bank cards, stablecoins, and/or other similar currencies. Upon receiving funding, the platform issues a virtual, localized card in the currency of the destination country or as a stored value on a user device. This card is tokenized and stored on the user's NFC-enabled device, allowing both online NFC device-to-device (tap-to-pay) transactions and offline NFC transactions to be conducted using the hybrid tokenization system described in this application. This eliminates the need to exchange physical cash and bridges the gap between different financial ecosystems.

In one embodiment, the platform incorporates a software development kit (SDK), which enables a mobile device to operate in dual NFC modes: as a payment card and as a payment terminal. In “card mode,” a mobile device such as a phone is tapped on payment terminals or other NFC devices, paying directly from an electronic wallet stored on the device to the tapped payment terminals or other NFC devices. In “terminal mode,” the NFC device with the SDK accepts MASTERCARD, VISA, and/or local payment cards. The SDK of the present invention eliminates the need for multiple physical cards, thereby enabling banks, stored-value card providers, and electronic wallet providers to issue soft cards to the users. This bi-directional functionality facilitates peer-to-peer (P2P) transactions and eliminates the need for costly physical point-of-sale (POS) infrastructure.

### Offline NFC Payment and SIM Integration

In one embodiment, the platform supports both traditional tap-to-pay transaction flows and a P2P stored-value model. The stored-value P2P model allows for device-to-device NFC transactions in both online and offline modes. The traditional tap-to-pay method uses the Europay, MASTERCARD, and VISA (EMV) payment tokenization specification, wherein the mobile wallet replaces sensitive card details with a device-specific Device Account Number (DAN), which is stored on a secure element embedded in the device. The present invention introduces a hybrid tokenization framework that uses a dual-layer token model to ensure security and support offline transactions. This includes:
Session-Based Tokens, dynamically generated for short-term use to help mitigate fraud risks.
Offline-Enabled Tokens, securely stored on a mobile device's local memory, on a secure element, SIM card, or eSIM chip, allowing tap-to-pay transactions even without internet connectivity.

In another embodiment, the platform is operable to facilitate traditional debit or credit card tap-to-pay NFC device-to-device transactions. Examples of this are included in U.S. Pat. No. 10,380,573, which is incorporated herein by reference in its entirety.

In another embodiment, the platform integrates directly with telecom and device infrastructure by embedding tokenized digital currency into the user's SIM or eSIM chip, creating what is referred to as an “NFC SIM Wallet.” This eliminates the need for cloud-based digital wallets or third-party apps and allows transactions to be executed via the device's NFC interface, drawing value directly from the SIM-stored balance. This architecture is particularly advantageous in regions where app ecosystems are fragmented, and internet access is unreliable.

In one embodiment, the SIM/eSIM module of the NFC SIM Wallet securely stores a tokenized digital currency (e.g., tokenized telecom-based currency). During payment, the device's NFC hardware transmits this stored data directly to a payment terminal or another NFC-enabled device. This functions similarly to a contactless card but draws from digital value stored on the SIM/eSIM rather than a traditional bank account. These offline transactions are verified locally using hash-based or token-authentication systems to mitigate fraud.

The platform further enhances security by implementing hash-based verification methods. Transactions are authenticated and stored directly on the device or SIM/eSIM card, allowing secure processing even in environments with limited or no connectivity unlike conventional systems that require an online connection for validation.

In one embodiment, to facilitate cross-network interoperability of traditional telecom issued digital currencies, the present invention allows for conducting transactions via the NFC payment platform for users from different telecom providers without being restricted to a single payment ecosystem. The platform achieves this through tokenizing the digital currency to be stored on device enabling online offline NFC device-to-device, card-to-device, or device-to-terminal payments, effectively reducing dependency on third-party apps or cloud-based wallets. This enables conducting transactions using digital currency independently of traditional banking systems.

In one embodiment, a digital wallet linked to the platform is funded with a preferred currency including telecom-issued digital currencies, cryptocurrencies (e.g., stablecoins, Bitcoin), debit cards, credit cards, traditional bank accounts, and/or local bank cards. Upon arriving in a foreign country (or in preparation for travel), the wallet automatically converts the funds in the wallet into a locally accepted currency. The wallet, linked to the user's NFC-enabled device, allows seamless transactions in the local currency. This process enables smooth conversion between crypto, mobile money, traditional fiat, debit cards, credit cards, traditional bank accounts, or a local bank card. The NFC-enabled device is then tapped to another NFC-enabled device to complete transactions in the local currency, providing a frictionless payment experience comparable to traditional contactless bank cards. For example, and not limitation, a cryptocurrency is loaded into a user's wallet on the platform, the platform is operable to convert the cryptocurrency into mobile money and/or a local currency/bank card of the based on the request of a user, and then the mobile money and/or local currency/bank card is subsequently able to be withdraw from or spend via the NFC payment system of the platform carried out by the NFC reader or transmitter on the mobile device. Conversely, mobile money is operable to be exchanged back into cryptocurrency or transferred to a bank account. This flexibility creates a financial ecosystem that allows for the movement of funds efficiently between digital and traditional or local financial infrastructures. In the current disclosure, “fiat currency” as used herein is described as any digital or physical government-issued currency exchanged via any mechanism including but is not limited to bank accounts, wires, debit cards, credit cards, online currency exchange platforms (e.g., PayPal, Apple pay, Venmo, Zelle), and/or checks.

### Tokenized Identity and KYC Framework

In one embodiment, the platform allows for the tokenization of a user's identification data to meet Know Your Customer (KYC) requirements while enhancing security and privacy for the user. Traditional KYC processes require users to submit personally identifiable information such as government-issued IDs (e.g., a passport), biometric data, and/or proof of address. The current invention allows for the uploading of government IDs, and any other information required. The platform then tokenizes a user's identification data, allowing it to be securely stored either on the user's device (e.g., on SIM/eSIM or on the mobile device storage) or the platform securely stores the information on a remote server/cloud server via platform. The tokenized ID is used for authentication without exposing raw personal data, thereby ensuring compliance with financial regulations while preserving user privacy. The tokenized ID is operable to be used to issue new localized cards, fund digital wallets, or authorize transactions without the need to re-scan documents.

When verification is required, the platform generates a temporary, one-time-use token that authorized institutions (e.g., mobile money providers, banks) use for validation. The platform supports a reusable tokenized ID, allowing users to be authenticated across multiple platforms without repeating verification processes. On-device biometric authentication (e.g., facial recognition) is operable to be utilized by the platform to authenticate the tokenized ID. Biometric authentication such as on-device facial recognition is integrated into the platform. This ensures that the initiation and completion of NFC-based transactions using the tokenized stored value is limited to only authorized users.

Tokenized identity data is also used to automate currency exchange in compliance with local banking regulations. For example, a traveler from the U.S. deposits stablecoins into their digital wallet on the platform and uploads a scan of their passport. The platform tokenizes the ID and stores it securely. Based on the destination of the user, the platform automatically converts stablecoin into a local currency (e.g., mobile money or airtime credits). The platform then tokenizes the local currency, enabling online or offline NFC device-to-device, card-to-device, or device-to-terminal payments.

In another embodiment, the platform embeds tokenized digital currency directly into a user's SIM or eSIM chip or stores it securely on the device. This enables access to financial services in emerging markets without needing internet connectivity or traditional local currency accounts, and without depending on third-party banking apps or cloud-based wallets.

In one embodiment, the platform allows mobile money providers to remotely top up stored balances on a user's device. When a top-up request is provided by a user, the provider updates the stored value on the SIM card or associated with the SIM card in real time. Alternatively, if a user is running low on local currency and has a funded wallet, the platform automatically contacts a local currency provider, shares the tokenized user ID and payment data, and receives an updated value for the user's SIM-based wallet.

### Peer-to-Peer (P2P) Offline Transactions and Ledger Design

In one embodiment, the platform comprises a P2P offline transaction system for mobile devices utilizing a stored value, enabling NFC-based digital payments in areas with limited or no internet connectivity. The platform facilitates device-to-device value transfer, secured through a tokenized government-issued identity, and recorded in a hybrid ledger architecture that combines individual transaction logs and netted balances. The offline transactions and ledger system of the platform is configured for high-frequency and/or closed-loop environments such as remote marketplaces, event venues, traveler pods, and/or crisis zones, where internet is unreliable, and cash is frequently used as a means for P2P transactions. The offline capabilities, combined with netting and tokenized trust layers, enable digital financial inclusion in environments excluded from the formal banking system.

In one embodiment, the platform allows each mobile device to operate in an offline mode and includes logic for initiating and receiving transactions via the NFC system built into the device. The transactions are stored locally and signed using a cryptographic identity derived from a tokenized version of a government-issued identification document. This cryptographic identity is generated and stored on-device and enables secure transaction authentication, identity verification, and dispute resolution in the absence of continuous connectivity.

In one embodiment, the platform incorporates a netting algorithm that computes net balances among a group of participants based on their recorded obligations. This debt/obligation ledger architecture enables group-level netting to reduce the total number of required payments. Each participant's device calculates bilateral net balances, signs the resulting summaries with its tokenized identity, and generates a Merkle-root snapshot of the transaction history for synchronization integrity. Each device maintains a net balance per counterparty and every transaction is signed and stored (or a hash of the transaction is kept) using the tokenized identities. When devices reconnect to the internet, the devices attempt to reconcile their netted balances. The debt/obligation ledger allows for the tracking of offline I owe you “IOUs” or the net balances across the parties, and calculates the minimum transactions needed to settle.

In one embodiment, the platform operates within a hybrid ledger framework consisting of two primary components: a detailed transaction log (history layer) and a netted counterparty balance matrix (fast-access layer). The transaction log stores signed transactions with associated metadata, including amount, currency, timestamp, location information of at least one device, foreign exchange (FX) rate, and/or counterparty. The netting layer maintains an up-to-date balance per counterparty, allowing for efficient debt tracking synchronization in resource-constrained environments.

In one embodiment, each transaction includes FX metadata, comprising a currency code, exchange rate, rate source identifier, timestamp, and/or location information of at least one of the devices. This enables multi-currency support and facilitates FX-aware netting where participants operate in different currencies.

In one embodiment, the sync logic is initiated when two or more devices reconnect after offline operation. Each device prepares a net summary, including net amount owed (net owed from A to B), a transaction nonce (last known transaction count or update), and a signed hash (signature over key sync values to verify integrity) or cryptographic signature. The devices compare summaries and validates integrity by checking that the sum of balances equals zero, that nonces are synchronized, and/or that signatures are valid. Upon successful validation, the platform optionally triggers a real-time or deferred settlement via a smart contract.

In one embodiment, if a mismatch is detected during synchronization due to missing transactions, signature mismatches/tampering errors, and/or timestamp drift the platform triggers a conflict resolution protocol where devices exchange diffs of signed transaction hashes, recompute net amount from source logs, and optionally revert to the most recent mutually agreed sync state. If resolution is not possible, the platform requires manual intervention or starts an automated dispute resolution module.

In one embodiment, each transaction is hashed and included in a Merkle tree structure maintained locally on the device where it is later uploaded to a cloud server and/or backed up via the platform. During synchronization, only the Merkle root and selected proofs are exchanged, allowing verification of transaction integrity without requiring full log transmission. This approach reduces bandwidth usage and improves sync performance in low-connectivity conditions.

In one embodiment, the platform enables minimal-settlement graph computation across group participants. Using group-level netting, the platform consolidates multiple micro-obligations into a reduced set of transactions. For example, 50 individual IOUs among 10 users are reduced to 3 optimized payments, improving user experience and reducing transaction fees.

In one embodiment, each mobile wallet includes an encrypted hybrid ledger structure secured using a secure enclave or trusted execution environment (TEE). The wallet comprises the following components: (1) a Netted Balances matrix storing real-time net amounts per counterparty, (2) a transaction log containing cryptographically signed transaction records, (3) a sync state object tracking last sync time and pending conflicts, and (4) a pruning config controlling local storage usage and audit retention policies.

Example code of a hybrid ledger transaction:

HybridLedger

| | |
|---|---|
| ├— | Wallet ID: 0xABC123... |
| ├— | Encrypted with: DeviceKey from Secure Enclave / TEE |

|

| | |
|---|---|
| ├— | NettedBalances (Fast Access Layer) |

| | | |
|---|---|---|
| \| | ├— | [counterparty_1] |

| | | | |
|---|---|---|---|
| \| | \| | ├— | currency: “NGN” |
| \| | \| | ├— | net_amount: − [symbol] 1200 |
| \| | \| | ├— | last_nonce: 15 |
| \| | \| | ├— | last_updated: 1712800000 |
| \| | \| | └— | signature: “sig(device_A\|B\|−1200\|nonce:15)” |

| | | |
|---|---|---|
| \| | ├— | [counterparty_2] |

| | | | |
|---|---|---|---|
| \| | \| | └— | ... |

|

| | |
|---|---|
| ├— | TransactionLog (Detailed History Layer) |

| | | |
|---|---|---|
| \| | ├— | tx_001.json |

| | | | |
|---|---|---|---|
| \| | \| | ├— | type: “send” |
| \| | \| | ├— | to: “device-uuid-B” |
| \| | \| | ├— | amount: 500 |
| \| | \| | ├— | currency: “NGN” |
| \| | \| | ├— | timestamp: 1712790000 |
| \| | \| | ├— | nonce: 11 |
| \| | \| | └— | signature: “sig(payload)” |

| | | |
|---|---|---|
| \| | ├— | tx_002.json |

| | | | |
|---|---|---|---|
| \| | \| | └— | ... |

| | | |
|---|---|---|
| \| | └— | ... |

|

| | |
|---|---|
| ├— | PruningConfig |

| | | |
|---|---|---|
| \| | ├— | prune_after_days: 30 |
| \| | ├— | max_log_size_mb: 10 |
| \| | └— | retain_for_audit: true |

|

| | |
|---|---|
| └— | SyncState |

| | |
|---|---|
| ├— | last_synced_with_server: 1712809999 |
| ├— | pending_conflicts: [ ] |
| └— | last_tx_nonce: 15 |

In one embodiment, the tokenized identity serves as the anchor of trust throughout the platform. The identity token is derived from a government ID and stored as a public-private key pair. This identity is used to sign transactions, sync payloads, and authorization messages, ensuring tamper-resistance and enabling verifiable KYC/AML compliance without exposing personal identifying information.

In one embodiment, upon sync or server reconnection, the platform submits Merkle-anchored summaries and signed netting results to a smart contract. The contract verifies identity signatures, confirms Merkle root integrity, and optionally triggers automatic settlement or updates the global ledger state. This hybrid architecture supports both decentralized (on-chain) and centralized (server-assisted) deployments. The current platform supports the use of tokenized identity, netted offline ledgers, and FX-aware micro-settlements for fully verifiable financial coordination system. By leveraging tokenized identity as a trust anchor and Merkle-anchored transaction validation, the platform ensures auditable synchronization and dispute resolution even when offline or in resource-constrained environments.

The platform of the present invention is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The platform is operable to use any of the aforementioned learning techniques alone or in combination.

Further, the platform is operable to utilize predictive analytics techniques including, but not limited to, machine learning (ML), artificial intelligence (AI), neural networks (NNs) (e.g., long short-term memory (LSTM) neural networks), deep learning, historical data, and/or data mining to make future predictions and/or models. The platform is preferably operable to recommend and/or perform actions based on historical data, external data sources, ML, AI, NNs, and/or other learning techniques. The platform is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

Referring now to the drawings in general, the illustrations are for the purpose of describing one or more preferred embodiments of the invention and are not intended to limit the invention thereto.

In one embodiment, the present invention further comprises an identity-anchored transaction attestation public key infrastructure (PKI) configured to authenticate a user during a card-not-present (CNP) transaction by cryptographically binding a verified government-issued identity to a payment credential. The platform utilizes an e-passport's NFC chip as a trusted identity source and generates a digitally signed attestation that is verifiable by any participant within the existing card-network trust chain.

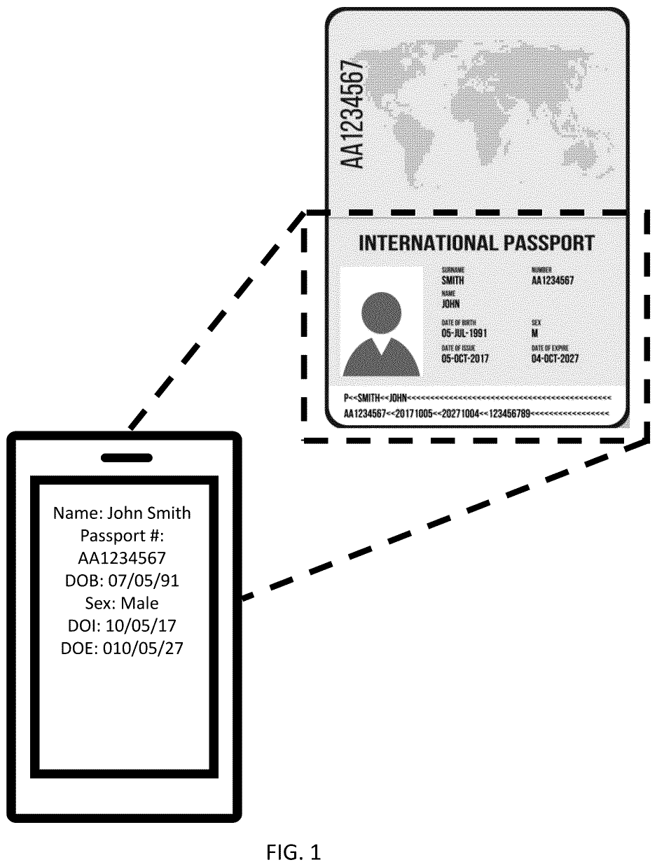

FIG. 1 illustrates a device-based passport camera reader according to one embodiment of the present invention. In one embodiment, the platform is operable to utilize at least one device camera to scan passport information from a passport of a user. The platform is operable to guide the user through a structured capture process, including real-time prompts instructing the user to adjust the passport's angle, distance, orientation, and/or lighting conditions until the passport's visual elements, including the Machine-Readable Zone (MRZ), are detectable and within acceptable quality thresholds, as determined by the platform. The system is operable to extract all passport information and/or data, including but not limited to holders' information, including full name, date of birth, place of birth, country of citizenship/residence, date of issue, date of expiration, passport photo, and/or passport number, wherein the platform is operable to extract the passport information and/or data via a scan from the Machine-Readable Zone (MRZ) of the passport, and wherein the platform is further operable to record the passport information and/or data for identity verification. User Passport information is operable to be encrypted and/or tokenized as described in the current application and stored on device, in at least one server, and/or in at least one cloud storage server.

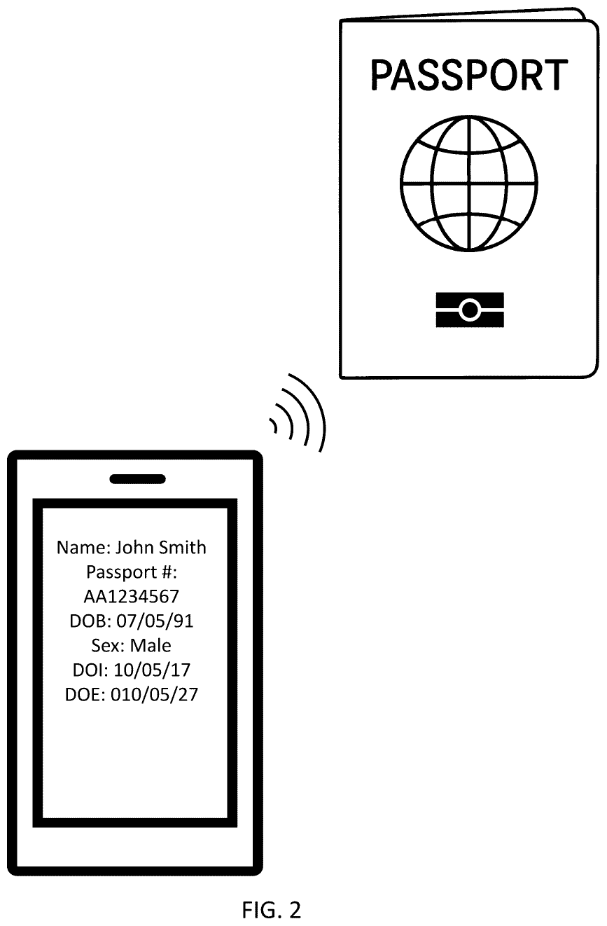

FIG. 2 illustrates a device-based passport near-field communication (NFC) reader according to one embodiment of the present invention. In one embodiment, the platform is operable to read identity data from the NFC readable chip on/in an e-passport using the NFC reader. The platform is operable to cross-verify the passport information gathered via scanning the passport with the device camera with the identity data from the e-passport. The identity data from an e-passport using the device's NFC reader includes, but is not limited to, data groups, holders' information, passport information, digital passport photo and/or a security digital signature.

The identification security system of a camera scanning the passport and the on-device NFC reader scanning the e-passport is operable to be utilized separately in isolation as a single layer identification system or is operable to be utilized in either order and checked against each other as a dual layer identity verification system. In a preferred embodiment, the identification security system is dual layer and first includes an on-device camera scanning information from the passport and then an on-device NFC reader scanning the e-passport information which verifies the information obtained by the camera. This dual layer system requires both layers to import the same verifiable information for the system to approve a user. This dual layer identity verification system represents a significant improvement in identification security technology necessary for digital conversion and transaction facilitation of the present invention and allows for fraud mitigation and chargeback protection for vendors through increased identification verification. The verified passport information and/or security digital signature is validated using the issuing country's public key obtained from the International Civil Aviation Organization (ICAO) PKI master list. This process confirms that the e-passport is genuine, unaltered, and issued by the appropriate governmental authority.

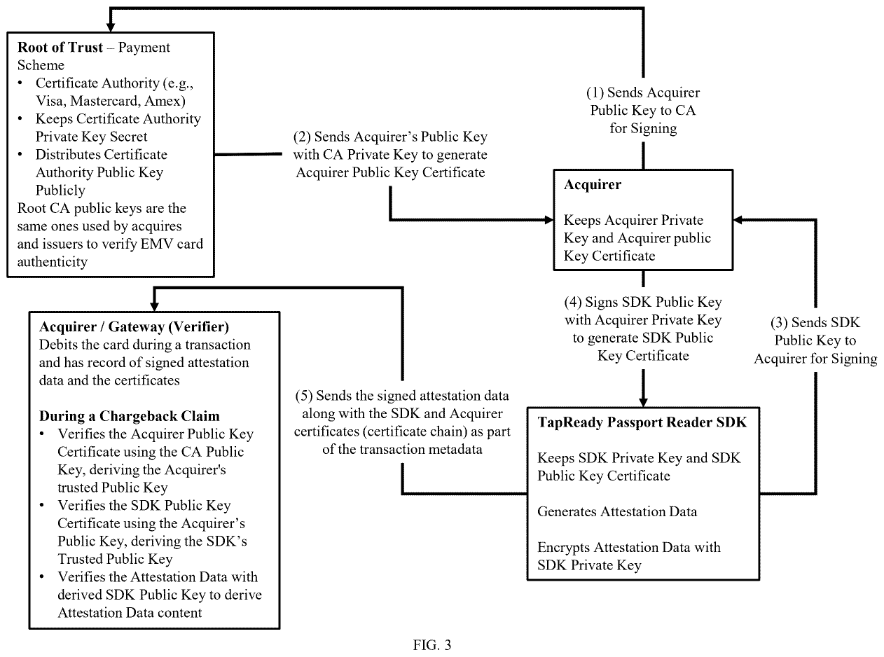

FIG. 3 illustrates a flowchart for an identity-anchored transaction attestation public key infrastructure, according to one embodiment of the present invention. In one embodiment, the verified passport identity is matched to a payment credential to authenticate the legitimate cardholder, wherein the platform is operable to collect a user's payment credential (e.g., Primary Account Number (PAN), tokenized PAN, and/or device-bound network token) and verify that the individual initiating the transaction and/or creating an account is the same individual whose identity is stored within the e-passport. The platform is operable to accomplish this by performing a facial biometric comparison between a live image captured at checkout and the face image extracted from the e-passport's NFC chip. The biometric comparison is operable to further include on-device biometrics (e.g., Face ID, fingerprint scanners, etc.).

In one embodiment, the facial matching procedure is executed locally through the SDK. The selfie image is processed, and a biometric comparison score is generated using a facial recognition model. If the comparison score exceeds a predetermined threshold, the platform is operable to confirm that the individual is a live user and that the biometric image corresponds to the verified passport holder.

In one embodiment, following successful identity verification, the platform is operable to construct an identity attestation payload. As used herein, an “attestation” refers to a cryptographically verifiable statement that certain attributes or facts have been validated by a trusted party. The attestation includes verified passport attributes such as the user's name, nationality, and date of birth, as well as hashes of the MRZ data and facial images, thereby ensuring user privacy while preserving verifiable integrity. The platform is also operable to incorporate a hash of the payment credential (e.g., hashed PAN or tokenized PAN), verified passport attributes (e.g., holder name, date of birth, etc.), a merchant identifier, a transaction timestamp, transaction location, and/or a cryptographically secured transaction receipt.

In one embodiment, the attestation is digitally signed using a private key embedded within the SDK. The SDK's certificate hierarchy chains to an acquirer-trusted certificate authority (CA), which itself is anchored to the existing card-scheme root CA used globally by issuers, acquirers, payment gateways, and POS terminals. The attestation messages are independently verifiable by any entity within the payment ecosystem.

The verifiability of PKI grants the attestation a level of trust, interoperability, and global portability that enables a payment card to be universally accepted at POS terminals and ATMs. As a result, metadata generated by the attestation integrates into existing dispute resolution, risk scoring, and liability frameworks used by card networks and acquirers.

In one embodiment, the signed identity attestation is transmitted to the acquirer and/or payment processor as part of the authorization during or after checkout. The attestation supports enhanced fraud detection and provides evidence of cardholder presence for the CNP transaction.

In one embodiment, upon receipt of the attestation, the acquirer or issuer performs verification using the certificate chain. Verification confirms that the e-passport signature was validated through the ICAO PKI, the live selfie matched the passport face image, the attestation was signed by a trusted, network-anchored private key, and/or the identity was cryptographically bound to the payment credential and merchant at a specific point in time.

In one embodiment, the attestation metadata is used in subsequent dispute resolution or chargeback proceedings. Because the attestation reflects cryptographically verified identity, time, merchant, and payment-credential binding, the platform provides strong evidence of cardholder presence, thereby reducing fraudulent disputes and improving chargeback defense for merchants and acquirers.

In one embodiment, the attestation payload is encoded in a structured JSON format. Sensitive fields are encrypted prior to transmission to the acquirer. An example of the encrypted payload structure includes, but is not limited to:

```
{
“attestation_version”,
  “purpose”,
  “transaction”: {
    “transaction_id”,
    “merchant_id”,
    “amount_minor,”
    “currency”,
    “timestamp,”
    “nonce”
  },
  “identity”: {
    “source”,
    “icao_doc_type”,
    “issuing_country”,
    “face_hash”,
    “mrz_hash”,
    “selfie_face_hash”,
    “name”
  },
}
```

In one embodiment, the fields within the JSON payload are hashed to preserve privacy while maintaining cryptographic verifiability. Attestation fields are included in one or more Merkle trees and/or chained signatures to support tamper detection and auditability.

In one embodiment, the attestation system integrates with the larger hybrid ledger architecture of the platform. The attestation serves as an anchor of trust within offline-capable transaction systems, NFC-enabled payment flows, and/or digital currency conversions described in the present application. The PKI represents a significant improvement to payment authorization and currency conversion and largely represents an improvement to traditional payment conversion computer technology.

In one embodiment, the identity-anchored transaction attestation system is further operable to utilize alternative government-issued identity documents in addition to e-passports. These identity documents are operable to include, but are not limited to, electronic national identity cards (eIDs), driver's licenses containing NFC-readable chips, regional smart-ID cards, residence permits, visa documents, and/or digital identity wallets issued by governmental authorities.

In one embodiment, the platform binds the verified identity attestation to a specific user device and/or user account. The device binding is performed by generating a cryptographic device fingerprint based on secure hardware identifiers and combining it with the attestation payload. This ensures that identity-verified transactions only originate from an attestation-authorized device. Device binding are operable to persist for subsequent transactions, enabling “continuous authentication” without repeated document scans.

In one embodiment, the attestation payload includes compliance metadata for regulated industries such as financial services, foreign-exchange platforms, and/or digital-asset environments. The system automatically formats compliance-ready identity attestations that confirm user verification without transmitting full identity documents.

In one embodiment, the platform integrates the attestation results into a machine learning fraud engine. The engine trains via historical attestation metadata, transaction success rates, biometric match scores, and/or device-binding results to compute a real-time risk score. The risk score is operable to be transmitted to the acquirer or issuer along with the attestation payload to aid in authorization decisions.

In one embodiment, the platform of the present invention comprises a universal checkout system which implements a “meta payment rail” configured to normalize interactions across a plurality of value stores, including but not limited to bank accounts, prepaid mobile-money accounts, card network accounts, stablecoin wallets, and/or similar storage mechanisms. The meta payment rail performs an operation where any underlying payment instrument is represented by a unified meta token while linking to the originating store of value.

In one embodiment, the meta rail does not maintain a user level ledger or independent store of value. Rather, it operates as a routing and settlement abstraction layer configured to receive merchant-initiated payments, determine the user selected payment method, obtain authorization and value movement instructions from the relevant partner system, and/or settle the transaction with the merchant preferred asset type over the merchant's supported rail. As used herein, a “rail” refers to a specific payment infrastructure/instrument (e.g., credit cards and POS). All debits, credits, and conversions occur on partner-maintained value stores and/or on a settlement anchor account maintained by the operator of the rail.

In one embodiment, the system enables tokenization of payment instruments rather than tokenization of value. When a user onboards a payment instrument, such as an M-Pesa account, a bank account, a stablecoin wallet, and/or a card number, the system generates a meta token that encodes a reference to the underlying partner system, the user's identity metadata, and required authorization credentials and/or delegated permissions. In one embodiment, the meta token does not represent monetary value, but serves as a persistent, cross-rail identifier for subsequent transaction routing.

For example, when a user tokenizes a mobile-money account, the system receives sufficient user credential information to securely authorize debits on a financial backing partner's API. The system then generates a meta token that is stored in association with the user's profile. This meta token is usable across any supported checkout environment, including POS, e-commerce checkout, and/or peer-to-merchant mobile interfaces, without requiring the creation of new instruments and/or accounts.

In another embodiment, the system maintains a single holding account or “settlement anchor” denominated in a designated fiat currency. The holding account enables collection of debits from at least one user selected payment instrument or rail and enables conversion into the merchant-preferred settlement instrument. No user balances are maintained on the system; instead, the holding account facilitates conversion and settlement operations.

When a merchant initiates a payment request through the universal checkout widget, the system receives a payment intent that specifies at least a transaction amount, currency, settlement instrument type, merchant identifier, and/or required metadata. The platform then retrieves from the system at least one meta token associated with the authenticated user.

When the user selects at least one meta token representing a particular payment instrument, the system invokes the partner interface corresponding to that instrument. For example, if “Pay with M-Pesa” is selected by a user while the merchant accepts only a denominated stablecoin, the system performs the following steps:
1) The merchant site displays a platform checkout widget. The platform then asks the user to select from a list of value stores.
2) The platform receives a selected source instrument/rail from a user (e.g., Pay with M-Pesa)
3) The platform executes the following:
   a) Debit Operation: Initiates a debit request to the mobile-money operator to transfer the specified amount from a users M-Pesa balance into the settlement anchor account.
   b) Conversion: Executes a currency-conversion routine to convert a partner's asset (e.g., Kenyan Shillings) into the anchor fiat currency.
   c) Credit: Performs a funding request to a stablecoin issuer, minting or transferring stablecoins of equivalent value to the merchant's stablecoin wallet.
   d) Confirmation: Communicates transaction confirmations to both the merchant and the user, each expressed in their native value types.

To both the merchant and the user, the transaction appears native: the merchant receives a stablecoin payment, and the user receives confirmation of an M-Pesa debit. The system absorbs the underlying transformation between payment instruments by operating across different settlement rails.

Merchants integrating with the disclosed system require only a single integration to the universal checkout API. The system eliminates the need for merchants to individually support card networks, bank transfer APIs, mobile-money systems, and/or blockchain-based assets. The meta rail of the current application determines the right conversion pathway and performs all settlements on behalf of the merchant.

In another embodiment, the checkout API dynamically adapts to merchant configuration, device specific layout, and/or user preferences while maintaining compliance with local regulatory and/or KYC requirements. The checkout API is operable to be embedded in web applications, mobile applications, and/or POS terminals.

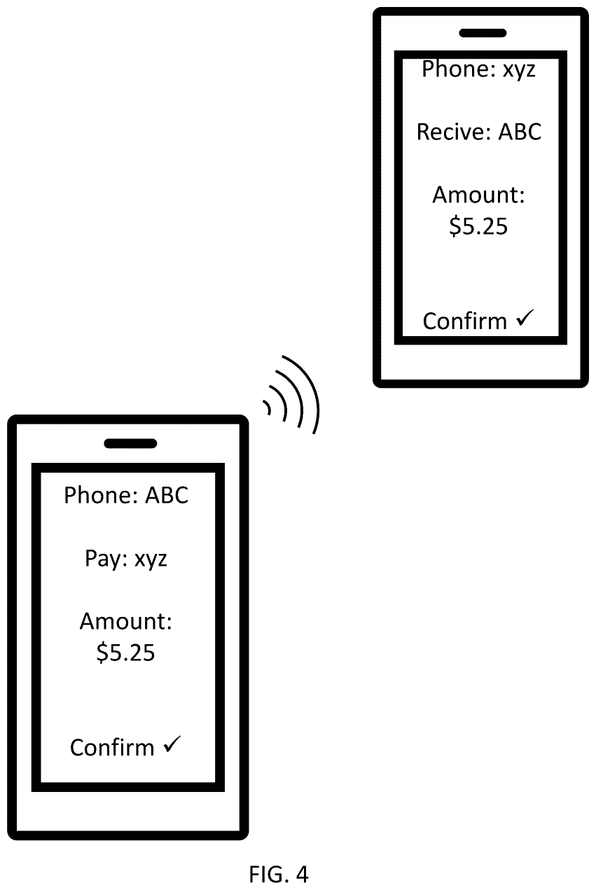

FIG. 4 illustrates device-to-device NFC payments and various transactions that are performed between a payee device and payor device in accordance with the presently described techniques. In general, the embodiments illustrated by FIG. 4 depict a transaction initiated between two NFC-enabled devices by way of an NFC tap operation, as will be explained in further detail below. For instance, FIG. 4 illustrates a payment by way of a credit card account, local bank card, or offline P2P stored value that is stored on the payor device in response to a payment request provided by a payee device. The platform is also operable to facilitate traditional tap-to-pay transactions or payments that include the payee device, the payor device, as well as the one or more financial servers which, in the present embodiment, include a bank server, a credit card verification server, and/or a mobile money provider server. To initiate the transaction, the payee device transmits a payment request to the payor device. As discussed above, the payment request includes the amount of the requested payment, the identity of the payee, as well as additional information regarding the nature or reason for the payment request. Accordingly, the payment request information is able to be transmitted from the payee device to the payor device through the establishment of an NFC connection by way of tapping the devices. In an alternative embodiment, the payment request information is able to be transmitted from the payor device to the payee device through the establishment of an NFC connection by way of tapping the devices or moving the devices close to each other. The payment request information includes identification of the payer or tokenized identification information, payment amount or the offline stored value, previous offline ledger information, and/or transaction details.

In one embodiment, one technique for establishing an NFC-based connection is through magnetic field induction, whereby a first NFC-enabled device acting as a host device generates an RF field, which in turn induces an NFC device located within a second device to transition from a passive state to an active state, thus establishing an NFC connection. Once established, information is exchanged between the devices by way of the NFC connection. While the NFC interface and the NFC device of the payee device are operating in the host mode, the payee device periodically emits pings. The corresponding NFC interface of the payor device receives the pings, thus causing the NFC device located within range of the payor device to awaken upon the detection of the NFC transmission transitioning from a passive mode to an active mode. Once in active mode, the NFC device of the payor device replies in response to the ping by sending an acknowledgement message which is received via the NFC interface of the payee device, completing the initiation. Following this initiation, the payee device and the payor device exchange transaction information.

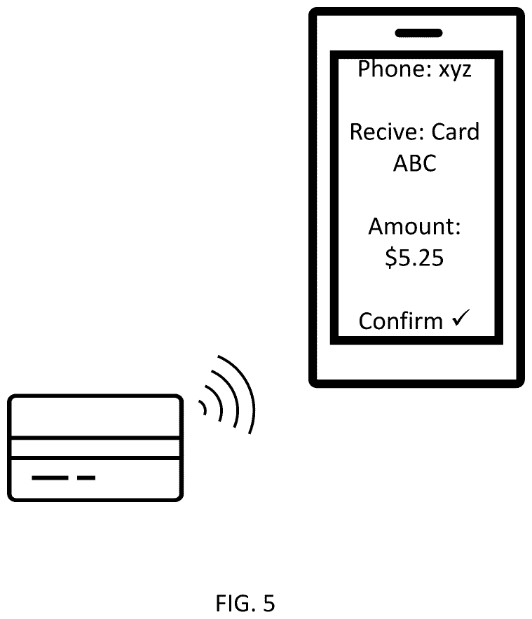

FIG. 5 illustrates card-to-device NFC payments according to one embodiment of the present invention. A payment by way of a credit card account, local bank card or any card with an NFC chip in response to a payment request provided by a payee device. The platform is operable to facilitate traditional tap-to-pay transactions or payments that include the payee device, the NFC-enabled card, as well as the one or more financial servers which, in the present embodiment, include a bank server, a credit card verification server, and/or a mobile money provider server. To initiate the transaction, the payee device transmits a payment request which is initiated by the NFC-enabled card.

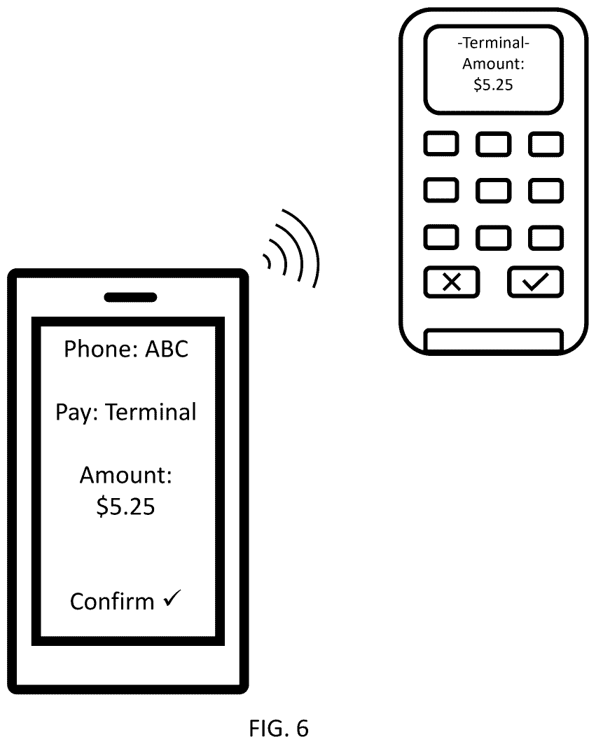

FIG. 6 illustrates device-to-terminal NFC payments according to one embodiment of the present invention. The platform is operable to facilitate traditional tap-to-pay transactions or payments that include the payor device, any NFC enabled POS terminal, as well as the one or more financial servers which, in the present embodiment, include a bank server, a credit card verification server, and/or a mobile money provider server.

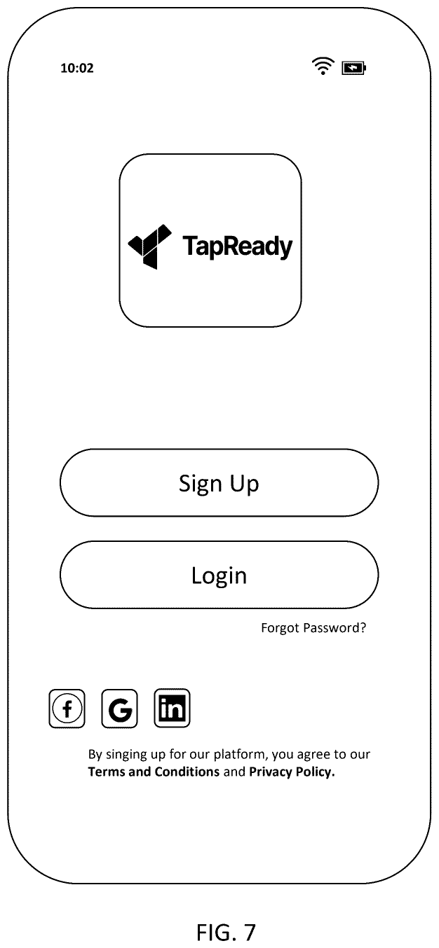

FIG. 7 illustrates a user device login/signup portal screen for the platform according to one embodiment of the present invention. The user login/signup portal on the platform is operable to allow for the signing up or logging in to an account to access a digital wallet and/or make or receive payments to other devices, cards, or terminals as previously described in the current application. The portal also includes links for connecting with social media pages of the platform and a forgot password button that will allow for the resetting of a password if the user has forgotten or misplaced the information.

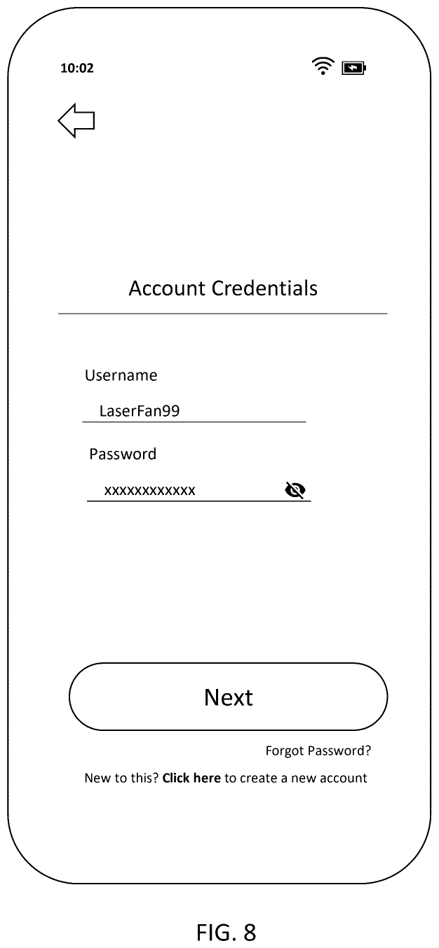

FIG. 8 illustrates a user device login screen for the platform according to one embodiment of the present invention. In one embodiment, the platform is operable to allow logging into to an account on the platform to access a digital wallet, transfer currency, and/or make or receive payments to other devices, cards, or terminals as previously described in the current application. The platform allows for logging onto an account using a password and/or username previously set by the user. In another embodiment, the platform allows for logging onto an account using biometric information as previously described in the current application. In one embodiment, the sign in page includes a password button that will allow for the resetting of a password if the user has forgotten or misplaced the information.

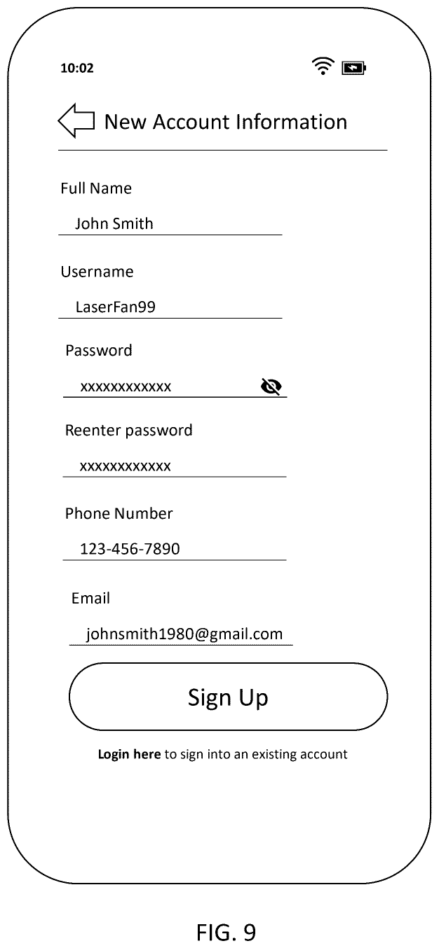

FIG. 9 illustrates a user device signup screen for the platform according to one embodiment of the present invention. In one embodiment, the platform allows for creating an account with the platform by entering personally identifiable information and banking information including: name, date of birth, phone number, address, a username, a password, bank account information, digital wallet information, telecom-based currency account information (e.g., mobile money account information), passport, government issued ID, biometric scan/information or permission, and/or any other necessary information.

In one embodiment, the server platform uses a system including at least one server computer and at least one user device. The at least one server computer is network-based or cloud-based. The at least one server computer includes at least one processor and at least one memory. The at least one user device includes, but is not limited to, a desktop computer, a laptop computer, a smartphone, and/or a tablet. The at least one user device is operable to display a graphical user interface (GUI) for the server platform through a native web page, a downloaded software, and/or a mobile application. The GUI is preferable optimized for display in mobile and/or web formats.

The server platform is operable to receive a request from at least one user device (e.g., a mobile phone, a computer, a tablet, etc.) to create an account and/or a user profile corresponding to one or more users. The server platform includes a plurality of accounts that are created upon registration with the server platform, with each account being linked to at least one user profile. Each of the at least one user profile includes account information identifying aspects of the user, user preferences, historical data for the user, and/or other data. Account information includes, but is not limited to, a name (e.g., first name, middle name, last name, nickname, username), a date of birth, a gender, an age, a race, an ethnicity, a physical address, a personal identification number (e.g., social security number (SSN), individual taxpayer identification number (ITIN)), at least one financial account (e.g., bank account number, credit card number, debit card number, digital wallet address, etc.), a job title, at least one email address, at least one phone number, a level of education, one or more alma maters, one or more additional authorized users with access to the account (e.g., a spouse, a child, etc.), and/or other user preferences. In one embodiment, the at least one user profile includes at least one designated means of contact for recovering account information (e.g., at least one email address, at least one phone number, at least one linked social media account, etc.).

In one embodiment, upon registration of a user profile and/or at a later time, the server platform receives answers to one or more challenge questions for a user profile. In one embodiment, the one or more challenge questions are selected from a preestablished list (e.g., What was your first pet?, What model was your first car?, etc.). In one embodiment, the server platform receives an input of a custom question and an answer for a user profile.

In one embodiment, the server platform prompts the user device to register one or more items of biometric information to associate with the user profile. In one embodiment, the biometric information includes one or more fingerprints, one or more retinal scans, one or more facial scans, and/or one or more voice samples (e.g., for voice pattern analysis). In one embodiment, upon registration of a user profile, the server platform prompts the user device to perform one or more typing tests in order to analyze a user's keystroke pattern. In one embodiment, in order to log-in to the user profile, the server platform prompts a user to perform a typing test and compares the results to the user's keystroke pattern registered in association with the user profile. In another embodiment, the keystroke pattern is recognized as the username and/or password is entered to log into an account. Examples of keystroke recognition systems able to be utilized with the present invention include, but are not limited to, that described in U.S. Pat. No. 6,954,862, which is incorporated herein by reference in its entirety. In one embodiment, at least one artificial intelligence module is used to detect and form a keystroke signature for each user and/or to recognize a user inputted keystroke pattern as matching the keystroke signature for a particular user profile.

In one embodiment, one or more of the user profiles on the server platform are associated with one or more other profiles or subprofiles. In one embodiment, one or more of the user profiles is able to set preferences and/or permissions for the other profiles or subprofiles. By way of example and not limitation, in one embodiment, one or more user profiles is a “parent” profile and able to set permissions for one or more child profiles including, but not limited to, visibility of account information associated with the one or more child profiles by other accounts, the ability of the one or more child profiles to direct message other profiles or receive direct messages from other profiles, the ability to participate in video calls and/or audio calls with other users, content viewing permissions (e.g., ability to view teen content, ability to view mature content, etc.), and/or other content permissions.

In one embodiment, the one or more of the user profiles is able to view information associated with the one or more other profiles or subprofiles (e.g., medical information, grades, activity performance stats). In one embodiment, the one or more of the user profiles is able to set appoints and manage a calendar for each of the one or more other profiles or subprofiles associated with the one or more of the user profiles.

The server platform is able to receive a username and a password from a user device in order to login to a user profile on the user device. In one embodiment, the server platform is able to receive a selection of “Forgot My Password” and receives a selection of one or more means of communication (e.g., at least one email address, at least one phone number). In one embodiment, the server platform automatically transmits a message to the one or more means of communication prompting to enter a new password. In another embodiment, the server platform automatically transmits a message to the one or more means of communication including the existing username and password information to allow the user to sign in.

In one embodiment, the server platform receives biometric information in order to log the user into the user profile. Biometric information includes, but is not limited to, retinal data, a facial image scan, one or more fingerprints, and/or voice pattern recognition. In one embodiment, biometric information includes a typing test to recognize a keystroke signature previously associated with the user profile.

In one embodiment, after successfully entering a username and password, the user device generates a challenge question GUI. In one embodiment, the server platform prompts for answers to one or more challenge questions associated with the at least one user profile. In another embodiment, the GUI on the user device includes a drop-down menu for a user profile to select one or more challenge questions and subsequently enter an answer matching a question and answer associated with the user profile. In one embodiment, the drop-down menu only includes questions previously associated with the user profile. In another embodiment, the drop-down menu includes questions having answers associated with the user profile as well as questions without answers associated with the user profile, forcing the user to know which questions have previously been addressed. In one embodiment, rather than being used as a subsequent step to enter a username and password, the challenge question GUI is required in order to authorize the server platform to send an account retrieval message to a designated account recovery communication means and/or to otherwise recover a username and password.

In one embodiment, the system includes an option for a user device to sign into a user profile via scanning at least one unique visual code. Examples of unique visual codes include bar codes, a quick response (QR) code, and/or any other form of visual code. After the user device scans the at least one unique visual code (e.g., via at least one camera and/or LiDAR sensor on the user device), the scan data is transmitted to the server platform. The server platform verifies the validity of the at least one unique visual code and/or matches the at least one unique visual code with the user profile. If the at least one unique visual code is successfully matched, then the user profile is logged in on the scanning user device.

In one embodiment, the system includes an option to log-in via at least one other device. In this system, when an attempt is made to log in on a first user device, the first user device automatically generates and displays a unique log-in code and a prompt to visit a log-in code page on a user device that is already signed into the user profile. Through the signed in user device (e.g., a mobile phone, a smart television, a computer, tablet, a smart watch, etc.), the server platform receives an input of the unique log-in code. Subsequently, the server platform automatically signs in the first user device to the user profile.

In one embodiment, in order to verify that the users logging in are legitimate users and not bots, the server platform generates at least one Completely Automated Public Turing test to tell Computers and Humans Apart (CAPTCHA). Upon the server platform receiving a selection that indicates a positive result for the at least one CAPTCHA, the user profile is successfully logged in.

In one embodiment, in order to login to a user profile, the user device transmits a login message to the server platform including location metadata. In one embodiment, the location metadata is generated by a Global Positioning System (GPS) chip found in the user device. In one embodiment, the server platform authenticates or rejects the login attempt based on the associated location metadata. By way of example and not limitation, if a user from one or more restricted countries (e.g., Argentina is restricted) attempts to login to a user profile, then the server platform automatically rejects the login attempt. In this embodiment, the server platform maintains a location blacklist, designating one or more locations from which login attempts will be rejected. However, in another embodiment, the server platform includes a location whitelist, designating a limited number of locations from which login attempts are able to be authenticated. This is particularly useful for security purposes and ensuring, by way of example and not limitation, that only login attempts made from a user's home are able to be accepted. In one embodiment, the whitelists and/or blacklists are global whitelists and/or blacklists that apply to all user profiles on the server platform. In another embodiment, the whitelists and/or blacklists are specific to each user profile, meaning locations are able to be restricted or allowed with respect to specific user profiles, but not with regard to other user profiles.

In one embodiment, the login page includes at least one button for logging in via other associated social media accounts (e.g., FACEBOOK, INSTAGRAM, LINKEDIN, GMAIL, YOUTUBE, REDDIT, TWITTER, MYSPACE, TUMBLR, MASTODON, etc.). The server platform receives a selection of one or more social media platforms from a user device and initiates an application programming interface (API) call to verify that the user device being used to login is signed into an account on the selected one or more social media platforms on the user device. If no login using the associated social media account has previously been attempted, then the server platform automatically generates a user profile corresponding to the associated social media account. If an existing user profile exists corresponding to the associated social media account, then the server platform validates login into the existing user profile. This process is useful, as it allows a user to login and access the server platform without having to create a new username and password for the server platform. Furthermore, in one embodiment, the server platform is configured to automatically retrieve data corresponding to the associated social media account via at least API call to a database of the social media platform. In one embodiment, data retrieved via these means include bibliographical data (e.g., name, address, contact information, etc.) and/or preference data (e.g., estimated political views, estimated shopping preferences, estimated content preferences, etc.). In one embodiment, retrieved bibliographical data is used to automatically fill in information corresponding to the generated user profile on the server platform. In one embodiment, retrieved preference data is used to filter and select media displayed for the user profile on the server platform.

One of ordinary skill in the art will understand that one or more of the above-mentioned authentication methods are able to be used in order to log in a user device into a user profile. In one embodiment, the system utilizes multifactor authentication, transmitting an authentication message via one or more communication means (e.g., phone number, email address, one or more linked social media accounts, etc.) including a link to authenticate a login attempt and/or a code to enter in order to complete the login attempt.

In one embodiment, the server platform automatically validates each user profile. In one embodiment, validation is performed by crawling social media, government databases, and/or banking databases via at least one web crawler. In another embodiment, validation is performed by a user taking and uploading one or more photographs of themselves and comparing it to the photo on the government issued ID provided to the platform by the user. In one embodiment, the one or more photographs are manually reviewed in order to check whether each user profile is properly validated. In another embodiment, the one or more photographs are automatically reviewed by an artificial intelligence module to validate each user profile. In one embodiment, the artificial intelligence module is trained with one or more images of similar documents and trained to recognize one or more fields (e.g., name, date, etc.) such that information from the one or more fields is able to be automatically registered and logged by the server platform.

### Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating computing resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008, and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain, and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention includes digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that an external party verifies a digital signature of a user using a public key but cannot replicate the digital signature since the external party does not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

### Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

### Tokenization

In one embodiment, the platform is operable to tokenize assets. A token is a piece of data that is stored on the distributed digital ledger and is operable to be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018, and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

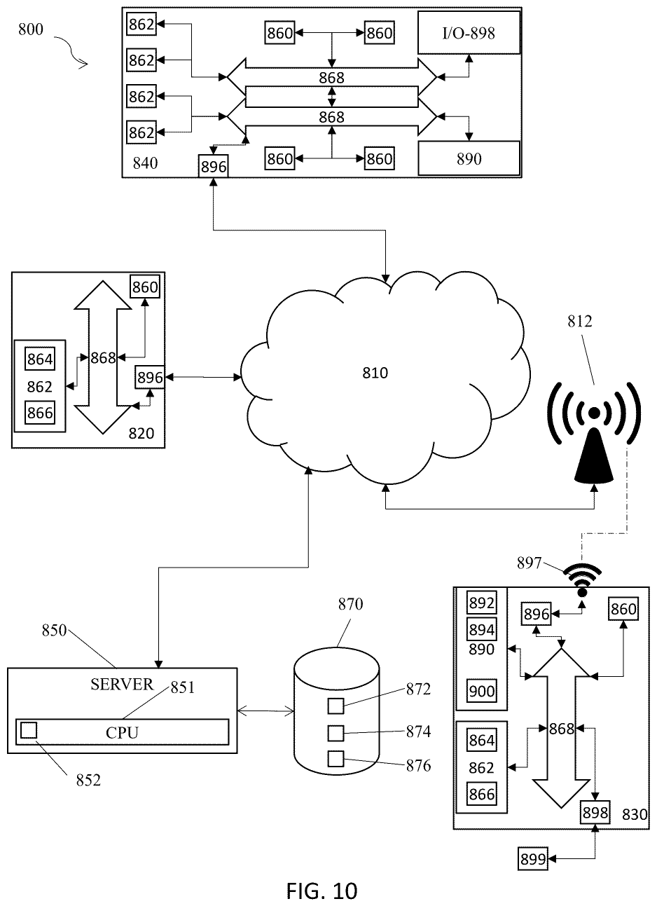

FIG. 10 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 10, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable to be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 10, is operable to include other components that are not explicitly shown in FIG. 10, or is operable to utilize an architecture completely different than that shown in FIG. 10. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The blockchain technology of the present application is based on existing communication protocols (e.g., HTTP, RPC), cryptography (grown from Public key cryptography in 1976), distributed peer-to-peer sharing mechanisms (e.g., Napster, bitTorrent), and a distributed set of databases kept in synchronization based on time. The blockchain technology is a technology that permanently records events or transactions on a network in a transparent, auditable, and irrefutable way. A blockchain ledger is stored on each blockchain node participating in or comprising a network. Blockchain nodes include, but are not limited to servers, mobile devices, work stations, or any networked client that can interface with an IP-based network and can operate an operating system capable of processing blocks. Blockchain is a loose specification rather than a specific implementation, which is capable of unlocking monopoly power over information in infrastructure systems for telecommunications, healthcare, finance, energy, and government. Blockchain also disintermediates “middle men” such as broker dealers, banks, transfer agents, or any third party in information or transactions that are utilized for trust in the transmittal of data or the execution of a transaction. n an introduction to blockchain applications in The Business of Blockchain by William Mougayar (2016), which is incorporated herein by reference in its entirety, it is established that just as the Web could not exist without the Internet, blockchains could not exist without the Internet, and thus, the use of blockchains within the systems and methods of the present invention provide that it is not merely an abstract idea, since it is inextricably tied to Internet technology.

The smart contract described and implemented in the platform of the current application is a computer protocol intended to digitally facilitate, verify, or enforce the negotiation or performance of a contract. In the context of blockchain, smart contracts are self-executing codes on a blockchain that automatically implements the terms of an agreement between parties.

The Location data described and implemented in the platform of the present invention is created in the present invention using one or more hardware and/or software components. By way of example and not limitation, location data is created using the Global Positioning System (GPS), low energy BLUETOOTH based systems such as beacons, wireless networks such as WIFI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router and thus is operable to determine the locations of these devices through their presence in the connection range of the wireless router.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for facilitating near-field communication (NFC) device-to-device transactions comprising:
a user device including an NFC interface, a processor, and a non-transitory memory;
a digital wallet stored on or accessible by the user device;
a tokenization engine configured to convert a telecom-issued currency, a fiat currency, or a cryptocurrency into one or more tokenized values;
a local ledger stored on the user device; and
an identity module configured to extract identity data from a machine-readable zone of a passport using a camera of the user device and to extract NFC-based identity data from an NFC-enabled passport chip of the passport using an NFC chip of the user device;
wherein the extracted identity data and the extracted NFC-based identity data are cross-verified and tokenized to create tokenized identity data for a user of the user device;
wherein the digital wallet is operable to store the one or more tokenized values;
wherein the NFC interface is configured to transmit the one or more tokenized values between the user device and a second user device via NFC;
wherein the local ledger includes a transaction log of signed transactions and a netted balance structure representing obligations between the user device and the second user device;
wherein the local ledger enables an offline token framework to execute the transmission of the one or more tokenized values between the user device and the second user device via NFC without network connectivity; and
wherein the transaction log of signed transactions includes the tokenized identity data for the user and tokenized identity data for a second user of the second user device.

2. The system of claim 1, further comprising a secure storage element including a secure enclave, SIM card, or eSIM, configured to store tokenized identity data and/or the digital wallet containing the one or more tokenized values.

3. The system of claim 1, wherein the NFC interface is operable to operate in dual modes including a card mode in which the user device emulates an NFC payment card or a terminal mode in which the user device accepts NFC payments from the second user device.

4. The system of claim 1, wherein the local ledger includes a Merkle tree structure configured to store the transaction log of signed transactions and generate Merkle roots for synchronization.

5. The system of claim 4, further comprising a smart contract interface configured to receive synchronized transaction summaries, verify identity signatures from the tokenized identity data for the user, the tokenized identity data for the second user, and the Merkle roots, and execute settlement operations.

6. The system of claim 1, wherein the netted balance structure is configured to compute net obligations between multiple counterparties to reduce a number of settlement transactions.

7. The system of claim 6, wherein the settlement transactions do not occur in near-real-time with respect to the transmission of the one or more tokenized values between the user device and the second user device via NFC.

8. A method for facilitating near-field communication (NFC) device-to-device transactions comprising:
converting, by a tokenization engine, a telecom-issued currency, a fiat currency, or a cryptocurrency into one or more tokenized values;
extracting, by an identity module, identity data from a machine-readable zone of a passport using a camera of a user device, wherein the user device includes a local ledger, an NFC interface, a processor, and a digital wallet;
extracting, by the identity module, NFC-based identity data from an NFC-enabled passport chip of the passport using an NFC chip of the user device;
cross-verifying and tokenizing the extracted identity data and the extracted NFC-based identity data to create tokenized identity data for a user of the user device;
storing, by the digital wallet, the one or more tokenized values;
transmitting, by the NFC interface, the one or more tokenized values between the user device and a second user device via NFC;
maintaining, by the local ledger, a transaction log of signed transactions and a netted balance structure representing obligations between the user device and the second user device; and
executing, by the local ledger, an offline token framework to execute the transmission of the one or more tokenized values between the user device and a second user device via NFC without network connectivity;
wherein the transaction log of signed transactions includes the tokenized identity data for the user and tokenized identity data for a second user of the second user device.

9. The method of claim 8, further comprising storing, in a secure storage element including a secure enclave, SIM card, or eSIM, the tokenized identity data and/or the digital wallet containing the one or more tokenized values.

10. The method of claim 8, further comprising operating the NFC interface in dual modes including a card mode in which the user device emulates an NFC payment card or a terminal mode in which the user device accepts NFC payments from the second user device.

11. The method of claim 8, further comprising storing, by the local ledger, the transaction log of signed transactions in a Merkle tree structure and generating Merkle roots for synchronization.

12. The method of claim 11, further comprising receiving synchronized transaction summaries via a smart contract interface, verifying identity signatures from the tokenized identity data for the user, the tokenized identity data for the second user, and the Merkle roots, and executing settlement operations.

13. The method of claim 8, further comprising computing, by the netted balance structure, net obligations between multiple counterparties to reduce a number of settlement transactions.

14. The method of claim 8, further comprising storing, in the netted balance structure, metadata including a currency of the NFC device-to-device transactions, an exchange conversion rate, a rate source identifier, and a timestamp.

15. A system for facilitating near-field communication (NFC) device-to-device transactions comprising:
a user device including an NFC interface, a processor, and a non-transitory memory;
a digital wallet stored on or accessible by the user device;
a tokenization engine configured to convert a telecom-issued currency, a fiat currency, or a cryptocurrency into one or more tokenized values;
a network-based ledger; and
an identity module configured to extract identity data from a machine-readable zone of a passport using a camera of the user device and to extract NFC-based identity data from an NFC-enabled passport chip of the passport using an NFC chip of the user device;
wherein the extracted identity data and the extracted NFC-based identity data are cross-verified and tokenized to create tokenized identity data for a user of the user device;
wherein the digital wallet is operable to store the one or more tokenized values;
wherein the NFC interface is configured to transmit the one or more tokenized values between the user device and a second user device via NFC;
wherein the network-based ledger includes a transaction log of signed transactions between the user device and the second user device; and
wherein the transaction log of signed transactions includes the tokenized identity data for the user and tokenized identity data for a second user of the second user device.

16. The system of claim 15, further comprising a secure storage element including a secure enclave, SIM card, or eSIM, configured to store tokenized identity data and/or the digital wallet containing the one or more tokenized values.

17. The system of claim 15, wherein the NFC interface is operable to operate in dual modes including a card mode in which the user device emulates an NFC payment card or a terminal mode in which the user device accepts NFC payments from the second user device.

18. The system of claim 15, wherein the network-based ledger includes a Merkle tree structure configured to store the transaction log of signed transactions and generate Merkle roots for synchronization.

19. The system of claim 18, further comprising a smart contract interface configured to receive synchronized transaction summaries, verify identity signatures from the tokenized identity data for the user, the tokenized identity data for the second user, and the Merkle roots, and execute settlement operations.

20. The system of claim 15, wherein the transaction log of signed transactions includes metadata including a currency of the NFC device-to-device transactions, an exchange conversion rate, a rate source identifier, and a timestamp.
